(19) United States
(12) Patent Application Publication
(10) Pub. No.: US 2009/0090522 A1
(43) Pub. Date: Apr. 9, 2009

(54) MATERIAL LOADER APPARATUS AND METHOD

(76) Inventor: Michael Platt, Yates City, IL (US)

Correspondence Address: HUSCH BLACKWELL SANDERS LLP, 190 CARONDELET PLAZA, SUITE 600, ST. LOUIS, MO, 63105-3441, US

(21) Appl. No.: 12/245,808

(22) Filed: Oct. 6, 2008

Related U.S. Application Data
(60) Provisional application No. 60/977,452, filed on Oct. 4, 2007.

(51) Int. Cl. A01B 21/08

(52) U.S. Cl. 172/539

(57) ABSTRACT

The invention includes a cutter drum (2) having at least one or multiple sharpened discs attached to it sections the earth. A pressure face (15) limits the cutter drum's penetration into the earth. The cutter drum's axle (12) is mounted to a frame (1). A pivoting mount (5) allow the device to move in an arc. Down pressure and depth of cutter drum penetration into the earth is controlled by a hydraulic cylinder (3) that connects the device's frame (1) to another frame structure (4) on the material transport platform (a truck, for example) on which the device is mounted.

### CROSS-REFERENCE TO RELATED APPLICATIONS

This application claims priority from U.S. Provisional Patent Application No. 60/977,452 filed Oct. 4, 2007.

### BACKGROUND OF THE INVENTION

1. Related Art

None

2. Field of the Invention

The present invention is a material loader.

### SUMMARY OF THE INVENTION

The invention includes a cutter drum (2) having at least one or multiple sharpened discs attached to it sections the earth. A pressure face (15) limits the cutter drum's penetration into the earth. The cutter drum's axle (12) is mounted to a frame (1). A pivoting mount (5) allow the device to move in an arc. Down pressure and depth of cutter drum penetration into the earth is controlled by a hydraulic cylinder (3) that connects the device's frame (1) to another frame structure (4) on the material transport platform (a truck, for example) on which the device is mounted.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of the cutter drum.

FIG. 2 is a front view of the cutter drum.

FIG. 3 is a front view of the cutter bar without cutter wheels.

### DETAILED DESCRIPTION OF THE PREFERRED EMBODIMENTS

The following description of the preferred embodiment(s) is merely exemplary in nature and is in no way intended to limit the invention, its application, or uses.

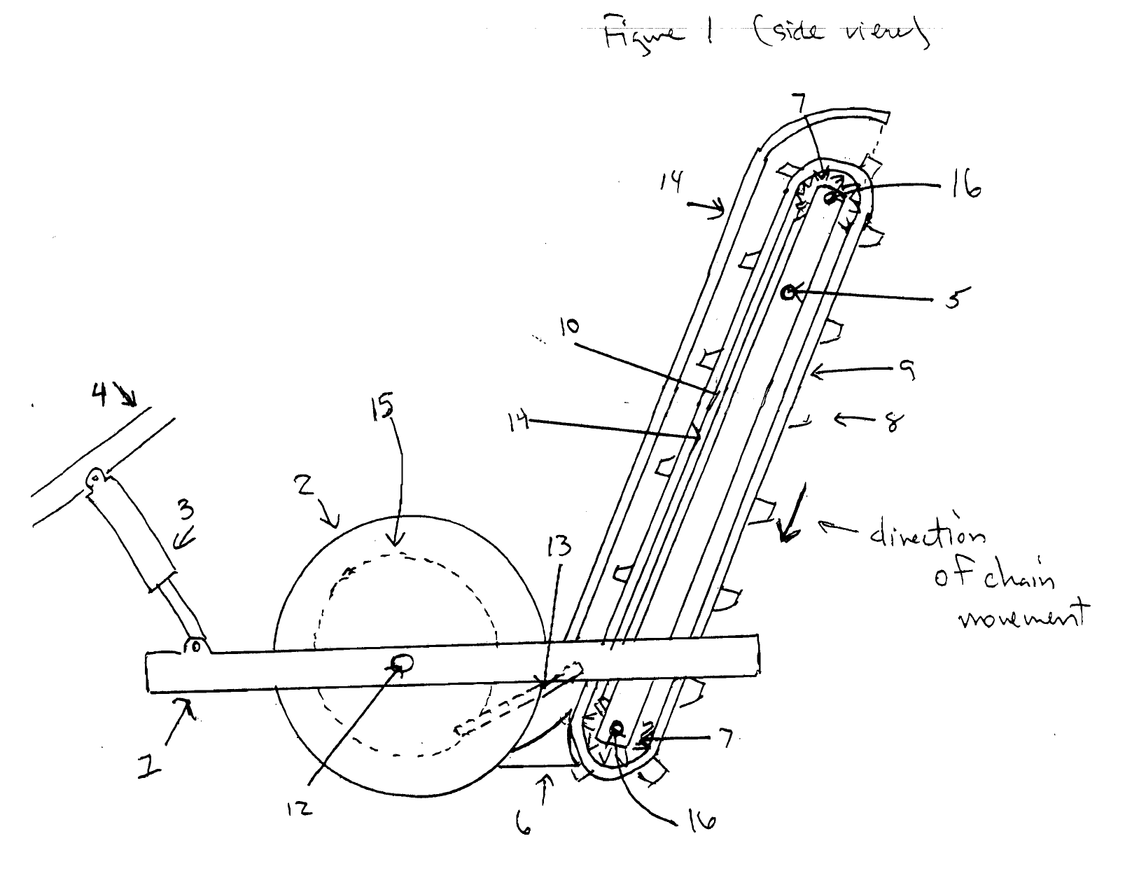

The present invention improves earth moving equipment such as is disclosed in PCT application US2006/23576, WO2006/138616, which is incorporated by reference herein. FIG. 1 is a cutter drum (2) having at least one or multiple sharpened discs attached to it sections the earth. A pressure face (15) limits the cutter drum's penetration into the earth. The cutter drum's axle (12) is mounted to a frame (1). A pivoting mount (5) allow the device to move in an arc. Down pressure and depth of cutter drum penetration into the earth is controlled by a hydraulic cylinder (3) that connects the device's frame (1) to another frame structure (4) on the material transport platform (truck, for example) on which the device is mounted.

Earth sectioned by the cutter drum is prevented from rolling up between the sharpened discs by a scraper (13) that is placed between the sharpened discs.

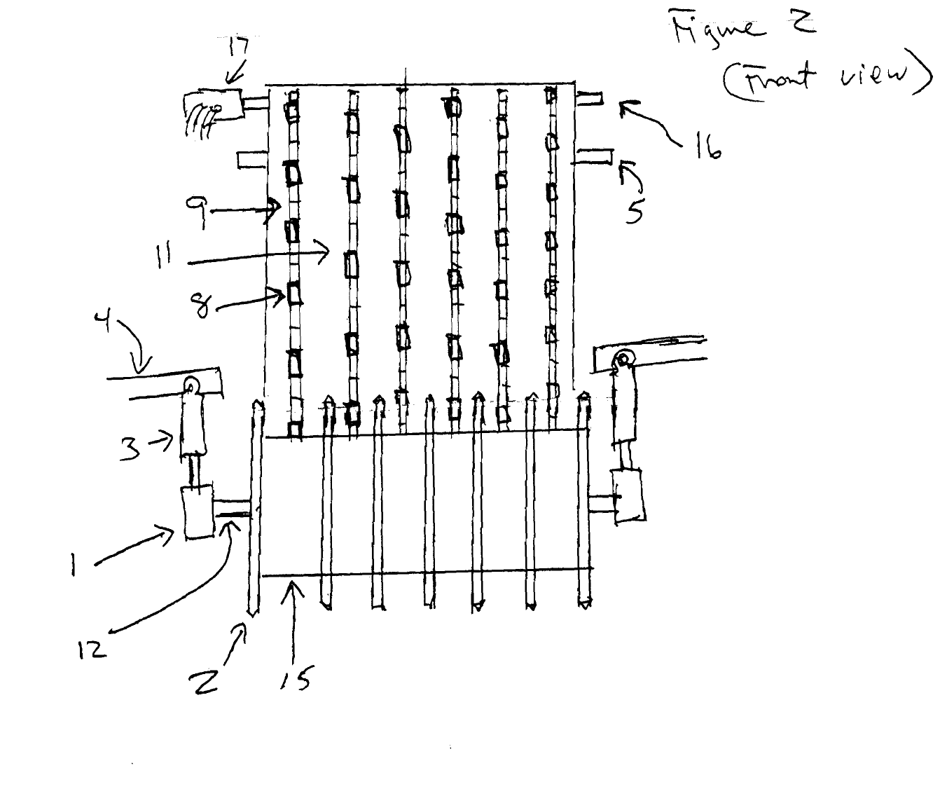

Behind the cutter drum is a cutting bar (6). Earth sectioned by the cutter drum rides up the cutter bar to where it is received by at least one or a multiple series of chains (9). The chains carry teeth (8). The chains are powered by sprockets (7). The sprockets are driven by an axle (16). The axle is driven by a hydraulic motor (17)(see FIG. 2).

The chains ride on an upper slide plate (11). A super structure frame (10) holds the parts in place. A cowling (14) above the chains and to the outside of the chain assemblies keeps the earthen material being carried upward by the teeth from rolling downward.

FIG. 2 shows the cutter drum with multiple sharpened discs (2). The pressure face (15) is shown inside of the outer circumference of the sharpened discs.

For each dimension between the sharpened discs (2), at least one chain (9) and tooth (8) assembly carries the sectioned earth upward on the upper slide plate (11).

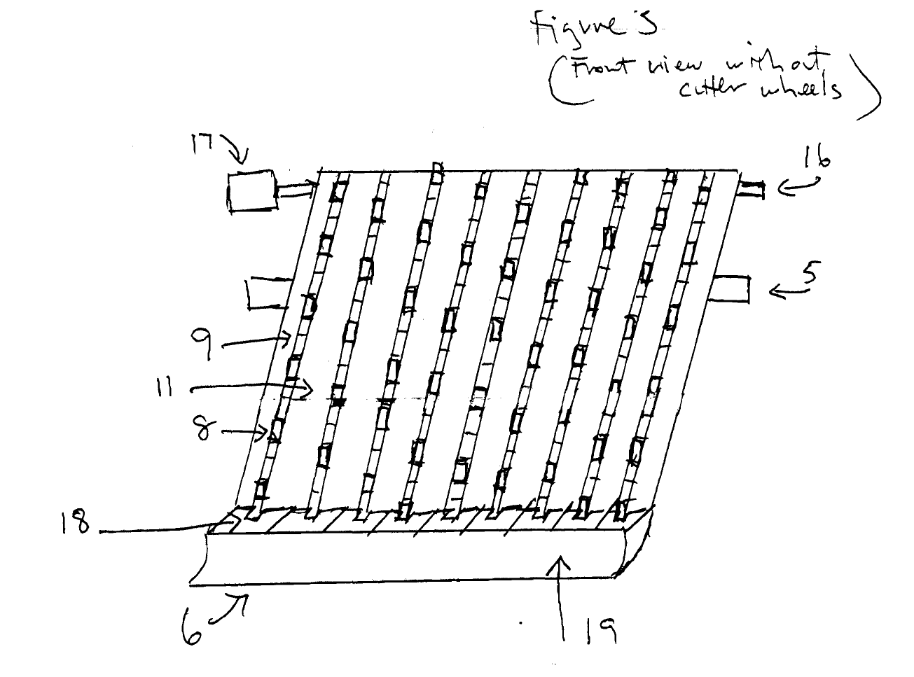

FIG. 3 shows the cutter bar (6). The cutter bar has a sharpened edge and a curved moldboard (19) which cuts and rolls the sectioned earth material upward. The earth is then received by a tooth plate (18).

The tooth plate (18) has notches recessed into it through which the teeth are allowed to freely pass.

The back edge of the tooth plate (18) and the upper slide plate (11) are in close proximity to prevent loss of material between the two components.

Accordingly, the depicted embodiment has at least one or multiple cutting discs that use a plate inside the outer circumference of the cutting disc to control depth penetration of the cutting discs. It further has at least one or multiple driven chains having teeth or paddles to lift material sectioned by a cutter drum. It has at least one or multiple sharpened discs whose down pressure is regulated, a notched plate that allows a tooth to freely pass through it, and a notched plate that allows a tooth to freely pass through it working in combination with a cutting bar that incorporates a straight or arced moldboard style surface.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An earth mover comprises:
a cutter drum (2) having at least one or multiple sharpened discs attached to it to section the earth;
a pressure face (15) limits the cutter drum's penetration into the earth;
the cutter drum's axle (12) is mounted to a frame (1);
a pivoting mount (5) allow the device to move in an arc;
wherein down pressure and depth of cutter drum penetration into the earth is controlled by a hydraulic cylinder (3) that connects the device's frame (1) to another frame structure (4) on the material transport platform (truck, for example) on which the device is mounted.
